(19) United States
(12) Patent Application Publication
(10) Pub. No.: US 2026/0227646 A1
(43) Pub. Date: Aug. 6, 2026

(54) LENSLET EYEGLASS LENS AND ITS DESIGN METHOD

(71) Applicant: SUZHOU MASON OPTICAL CO., LTD., Suzhou, Jiangsu (CN)

(72) Inventors: Chunmei ZENG, Suzhou, Jiangsu (CN); Jialing HOU, Suzhou, Jiangsu (CN); Haomo YU, Suzhou, Jiangsu (CN); Xiaoyi CHEN, Suzhou, Jiangsu (CN)

(21) Appl. No.: 19/151,440

(22) PCT Filed: Sep. 2, 2024
(86) PCT No.: PCT/CN2024/116295

§ 371 Date: Jul. 28, 2025

(30) Foreign Application Priority Data
Sep. 21, 2023 (CN) 202311219214.3

(51) Int. Cl. G02C 7/02; G02C 7/06

(52) U.S. Cl. CPC G02C 7/022; G02C 7/024; G02C 7/066; G02C 2202/24

(57) ABSTRACT

the lenslet eyeglass lens and its design method, comprises: the primary lens, the primary lens has the modulation zone, and the primary lens includes the first noumenon within the modulation zone; the lenslet, the lenslet includes a first lens and a second lens, the first lens is connected to the first noumenon and is configured to create defocus when combined with the first noumenon, and the second lens is also connected to the first noumenon and is configured to create a diffuse plaques when combined with the first noumenon; the second lens is connected to the first lens and exposes a part of the first noumenon, such that the modulation zone can concurrently generate a clear visual signal, a defocus signal, and a diffuse plaques modulation signal. The eyeglass lens of the present application make it possible to simultaneously cover the first lens, the second lens, and the first noumenon as much as possible when the pupil sweeps across the lenslet area, thereby providing the lens wearer with continuous and balanced multiple peripheral retinal stimulation signals and realizing the stimulation mechanism for inhibiting the growth of the eye axis.

The present invention claims a priority of a Chinese patent application No. 202311219214.3, titled “LENSLET EYEGLASS LENS AND ITS DESIGN METHOD”, filed with the China National Intellectual Property Administration (CNIPA) on Sep. 21, 2023, the disclosures of which are incorporated by reference herein in its entirety.

### TECHNICAL FIELD

The embodiments of the present application relate to, but are not limited to, the field of ophthalmic optics technology, and specifically relate to the lenslet eyeglass lens and its design method.

### BACKGROUND

Numerous optical intervention means have the issue of decreased visual quality of peripheral retinal imaging, multifocal peripheral defocus eyeglass lens create defocused areas in the mid-periphery of the retina, resulting in blurred peripheral vision and thus causing the problem of decrease of contrast sensitivity in some of the frequency zones during the initial wearing period, therefore, the decrease in visual quality within a certain degree correlates positively with the effectiveness of interventions for suppressing the progression of myopia. In practice, however, the optical methods that cause defocus are also related to the diffuse plaques of fuzzy state, and there are few reports on the means of intervening in the progression of myopia or hyperopia by coexisting defocus signal and diffuse plaques of fuzzy state.

### Technical Problem

The present application provides the lenslet eyeglass lens and its design method, aiming to provide an eyeglass lens which coexists diffuse plaques modulation signal and defocus signal and forms multiple signal competition on the retina.

### SUMMARY OF THE INVENTION

The following is an overview of the topics described in detail in the present application. This overview is not intended to limit the protection scope of the claims.

In the first aspect, provided a lenslet eyeglass lens, including:
a primary lens, the primary lens has a modulation zone, and the primary lens comprises a first noumenon within the modulation zone;
a lenslet, the lenslet includes a first lens and a second lens; the first lens is connected to the first noumenon, and is configured to create defocus when combined with the first noumenon; the second lens is also connected to the first noumenon, and is configured to create diffuse plaques when combined with the first noumenon; the second lens and the first lens are connected, and exposes a part of the first noumenon, such that the modulation zone can concurrently generate clear visual signal, defocus signal, and diffuse plaques modulation signal.

Optionally, the primary lens has a clear vision zone, the primary lens comprises a second noumenon within the clear vision zone, the modulation zone surrounds the clear vision zone, and the second noumenon and the first noumenon are connected, the center of the clear vision zone coincides with the optical center of the primary lens, the clear vision zone lies within a region 3 mm to 6 mm away from the optical center, and the modulation zone lies within a region 3 mm to 35 mm away from the optical center;
the area of the modulation zone is S₁, and the projected area of the lenslet within the modulation zone along the direction perpendicular to the first noumenon is S₂, satisfying: 0.5≤S₂/S₁≤0.8.

Optionally, the refractive power of the first lens is P₁ D, and the refractive power of the first noumenon is P₀ D, satisfying: 2.5≤|P₁-P₀|≤8.0.

Optionally, the refractive power of the second lens is P₂ D, and the refractive power of the first noumenon is P₀ D, satisfying: 10≤|P₂-P₀≤32.

Optionally, the refractive power of the first lens is P₁ D, and the refractive power of the second lens is P₂ D, satisfying: 8≤|P₂-P₁|≤30.

Optionally, the sagittal height of the first lens is H₁ μm, and the sagittal height of the second lens is H₂ μm, satisfying: 2≤H₂/H₁≤20.

Optionally, the sagittal height of the first lens H₁ μm satisfies: 0.5≤H₁≤5.

Optionally, the sagittal height of the second lens H₂ μm satisfies: 1≤H₂≤10.

Optionally, the first noumenon and the second noumenon are integrally molded.

Optionally, the primary lens includes the second optical surface on the eye-facing side and the first optical surface facing away from the second optical surface; and the lenslet is located: on the first optical surface; or, on the second optical surface; or, between the first optical surface and the second optical surface.

Optionally, the shape of the first optical surface and/or the second optical surface is selected from at least one of spherical surface, aspherical surface, or freeform surface.

Optionally, the shape of the first lens is selected from at least one of spherical surface, aspherical surface, toroidal surface, cylindrical surface, or freeform surface; and/or

Optionally, the shape of the second lens is selected from at least one of spherical surface, aspherical surface, toroidal surface, cylindrical surface, or freeform surface.

Optionally, the diameter of the first lens and/or the second lens are within 0.1 to 2 mm.

Optionally, the first lens and/or the second lens are the circular convex lens or the circular concave lens.

Optionally, the sum of the diameter of the first lens and the diameter of the second lens is less than or equal to the pupil diameter.

Optionally, the first lens and the second lens are tangential or contiguous at the edges thereof.

Optionally, the first lens and the second lens are connected alternately in sequence.

Optionally, the diffuse plaques produced by light passing through the second lens on a retina has a first RMS radius value, and the diffuse plaques produced by light passing through the first lens on the retina has a second RMS radius value, with the first RMS radius value being larger than the second RMS radius value.

In the second aspect, the present application also provides the design method of the lenslet eyeglass lens, comprising the following steps:
providing a primary lens, the primary lens has a clear vision zone and a modulation zone, the modulation zone surrounds the clear vision zone, the primary lens comprises a first noumenon in the modulation zone; and grids are arranged in an array in the modulation zone and connected to each other;
providing a first lens, the first lens is disposed within the grid and connected to the first noumenon, configured to create defocus when combined with the first noumenon;
providing a second lens, the second lens is disposed within the grids and connected to the first noumenon, configured to create diffuse plaques when combined with the first noumenon;
the first lens and the second lens are connected and expose a part of the first noumenon, such that the modulation zone concurrently generates clear visual signal, defocus signal, and diffuse plaques modulation signal.

Optionally, the grids are shaped as at least one kind among regular polygon, circle, or ellipse.

Optionally, the grids are shaped as regular hexagon, and the first lens and/or the second lens are shaped as inscribed circles within the hexagon.

Optionally, the step of providing the primary lens further comprises: determining the shape parameter of the primary lens based on the prescription and the refractive index of the material of the primary lens and establishing the primary lens model;
the step of providing the first lens further comprises: determining the shape parameter and the diameter of the first lens; determining the position of the first lens in the modulation zone according to the layout of the grids; and forming the first lens on the surface of the primary lens model;
the step of providing the second lens further comprises: determining the shape parameter and the diameter of the second lens; determining the position of the second lenses in the modulation zone based on the layout of the grids; and forming the second lenses on the surface of the primary lens model.

Optionally, the step of determining the shape parameter of the second lens further comprises:
conducting an optical simulation on the primary lens model with the first lens and the second lens being formed on the surface thereof, to obtain the size and shape of the diffuse plaques generated by the light passing through a maximum off-axis field of view of the second lens on the retina, thereby determining the RMS radius value of the diffuse plaques;
keeping the diameter of the second lens constant, gradually changing the single-sided mean power or the sagittal height of the second lens, and establishing a relationship between the single-sided mean power or the sagittal height and the RMS radius value of the diffuse plaques by regression analysis;
based on the RMS radius value of the diffuse plaques added for a lens wearer, using this relationship to determine the single-sided mean power or the sagittal height of the second lens, thereby obtaining the shape parameter of the second lens.

### TECHNICAL EFFECT

Compared with the prior art, the eyeglass lens of the present application have clear vision signals, defocus signals and diffuse plaques modulation signals in the modulation area at the same time, and the area of the three stimulation signals is basically balanced, so that when the pupil scans the area of the lenslet, the first lens, the second lens and the first noumenon can be covered as much as possible at the same time, thereby providing the wearer with continuous and balanced multiple retinal peripheral stimulation signals, realizing the stimulation mechanism of inhibiting the growth of the eye axis; the diffuse plaques modulation signal causes more blurred peripheral imaging on the retina, and the reduced visual quality of the imaging is quantified through the regulation of the diffuse plaques, and the competition between the stimulation signals is used to further intervene in the progression of myopia or hyperopia.

The design method of the present application, through a grid array layout, can adjust the proportion of various signals in a certain area in a convenient and evenly distributed manner, so that within the pupil scanning range, the stimulation area of various types of signals received by each area can remain approximately constant or increase a certain signal at a certain proportion. In addition, by adjusting the size of the diffuse plaques of a part of the lenslet imaging, the MTF, PSF and spot diagram evaluation methods are used simultaneously to evaluate the imaging quality of the peripheral retinal area, and it is found that the imaging quality of the peripheral retinal area decreases in the form of an increase in the diffuse plaques, and the amount of decrease is correlated with the progression of the intervention refractive error.

### BRIEF DESCRIPTION OF DRAWINGS

FIG. 1 is a front view of the lenslet eyeglass lens provided by the embodiments of this application;

FIG. 2 is a partially enlarged schematic diagram of the lenslet eyeglass lens provided by the embodiments of this application;

FIG. 3 is an optical system diagram of a lens-eye model in the myopic form provided by the embodiments of this application;

FIG. 4 is a partially enlarged schematic diagram of another lenslet eyeglass lens provided by the embodiments of this application;

FIG. 5 is a schematic diagram of the positional relationship between the first lens and the first noumenon within the YOZ optical axis section provided by Embodiment 1 of this application;

FIG. 6 is a diagram of the positional relationship between the first lens, the second lens on the Y-axis, and the adjacent first lens and second lens in the horizontal direction provided by Embodiment 1 of this application;

FIG. 7 is a projection diagram of the reference plane of the first lens or the second lens not on the Y-axis onto the XOZ plane provided by Embodiment 1 of this application;

FIG. 8 is a diagram of the size and shape of the diffuse plaques of the corresponding lens-eye system under different powers of the second lens provided by Embodiment 1 of this application;

FIG. 9 is a scatter plot and a fitted straight line of the single-sided mean power of the second lens and the RMS radius of the system diffuse plaques provided by Embodiment 1 of this application;

FIG. 10 is a schematic diagram of the positional relationship between the parabolic surface of the second lens and the first noumenon within the YOZ optical axis section provided by Embodiment 2 of this application;

FIG. 11 is a diagram of the size and shape of the diffuse plaques of the corresponding lens-eye system under different sagittal heights of the second lens provided by Embodiment 2 of this application;

FIG. 12 is a scatter plot and a fitted straight line of the sagittal height of the parabolic surface of the second lens and the RMS radius of the system diffuse plaques provided by Embodiment 2 of this application;

Description of the main attachment markings: 10—the primary lens, 101—the first noumenon, 102—the second noumenon, 103—the optical center, 104—the second optical surface, 105—the first optical surface, 20—the lenslet, 201—the first lens, 202—the second lens, 100—the modulation zone, 200—the clear vision zone, 300—grid.

### DETAILED DESCRIPTION OF EMBODIMENTS

The technical solutions in the embodiments of the present application will be described clearly and completely in the following in conjunction with the accompanying drawings in the embodiments of the present application, and the described embodiments are only a part of the embodiments of the present application and not all of the embodiments. Based on the embodiments in this application, all other embodiments obtained by a person of ordinary skill in the art without making creative work fall within the scope of protection of this application.

The disclosure hereinafter provides many different implementation manners or examples to implement different structures of this application. To simplify the disclosure of this application, the components and settings of specific examples are described hereinafter. Of course, they are only examples and are not intended to limit this application.

The applicant has found that in recent years, the number of myopic patients has been continuously increasing, showing a trend of rising year by year. And high myopia will increase the risk of vision loss for myopic patients. Therefore, it is very important to take measures to prevent and control myopia. At present, the recognized optical intervention means with clinical significance, whether orthokeratology lens, multifocal soft contact lens or multi-point defocus eyeglass frames in the form of lenslet arrays, all have the situation of decreased visual quality of peripheral retinal imaging. Researches have shown that multifocal peripheral defocus eyeglass will form defocus areas in the mid-peripheral part of the retina, resulting in decreased vision, blurred peripheral vision, and the interference of blurred vision in the mid-peripheral area may cause the decrease of contrast sensitivity in some frequency regions during the initial wearing period. With the prolongation of the wearing time, the visual interference of the blurred peripheral images may be gradually adapted by the brain, and there is no significant difference from ordinary single-focus eyeglass frames. This confirms that the decrease in visual quality within a certain extent is positively correlated with the intervention effect of inhibiting myopia progression. Previous animal experiments and clinical practices have shown that the competitive existence of clear vision signals and defocus stimulation signals in the macular center and the peripheral retina is an important factor in intervening in the progression of myopia or hyperopia. And in all previous experiments, all the optical methods that cause defocus are also related to the diffuse plaques in the blurred state. At present, there are already many lens technical solutions for the independent design of peripheral defocus and diffuse plaques, but there is still a lack of technical solutions that coexist peripheral defocus with the regulation of diffuse plaques and thus provide methods for regulating diffuse plaques.

Based on these, it is necessary to provide the lenslet eyeglass lens and its design method, especially to provide an eyeglass lens in which diffuse plaques and defocus signals coexist and form a competition of multiple signals on the retina, as well as its design method, so as to solve the above problems.

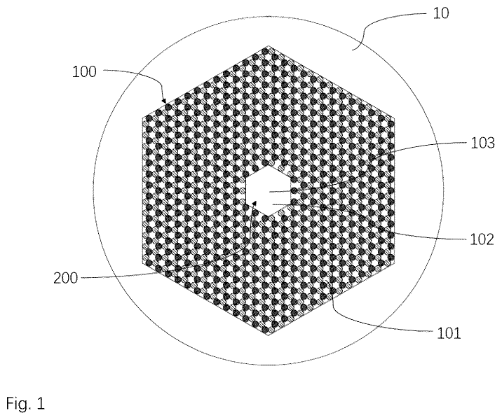

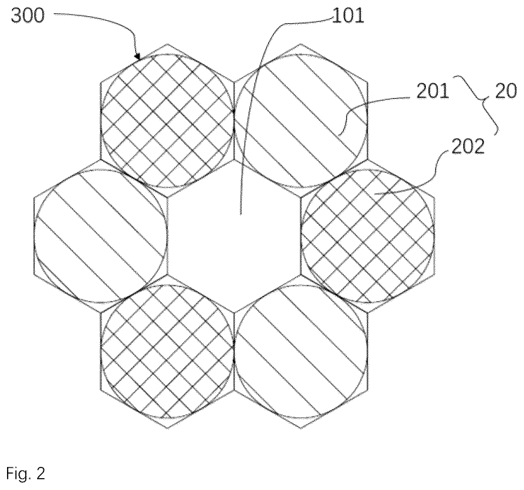

Referring to FIGS. 1 and 2, this embodiment provides the lenslet eyeglass lens, including the primary lens 10 and the lenslet 20; the primary lens 10 has the modulation zone 100, and the primary lens 10 comprises the first noumenon 101 within the modulation zone 100; the lenslet 20 comprises a first lens 201 and a second lens 202; the first lens 201 is connected to the first noumenon 101 and is configured to create defocus when combined with the first noumenon 101; the second lens 202 is also connected to the first noumenon 101 and is configured to create a diffuse plaques when combined with the first noumenon 101; the second lens 202 is connected to the first lens 201 and exposes a part of the first noumenon 101, such that the modulation zone 100 can concurrently generate a clear visual signal, a defocus signal, and a diffuse plaques modulation signal.

It can be understood that the lenslet 20 of the eyeglass lens in this embodiment is arranged in a grid array pattern, so that the modulation zone 100 has clear vision signals, defocus signals, and diffuse plaques modulation signals simultaneously, and the area of the regions of the three stimulation signals remains generally balanced, such that when the pupil sweeps across the area of the lenslet, it can simultaneously cover the first lens 201, the second lens 202, and the first noumenon 101 as much as possible, thereby providing the lens wearer with continuous and balanced multiple peripheral retinal stimulation signals, the diffuse plaques modulation signal causes more blurred peripheral imaging on the retina, quantifies the reduced visual quality of the imaging through diffuse plaques regulation, and achieves the effect of further intervening in the progression of myopia or hyperopia through the mutual competition of various stimulation signals.

Among them, the first noumenon 101 of the primary lens 10 is used to correct the symptoms of refractive errors of the lens wearer, and the first lens 201 and the second lens 202 respectively give the lens wearer multiple unclarity correction stimulation signals on the peripheral retina within the range of the pupil sweep, providing more forms of stimulation mechanisms for intervening in the development of refractive errors. The first lens 201 on the lenslet 20 causes the light to converge or diverge, making the imaging on the peripheral retina fall in front of or behind the retina, creating peripheral defocus, thereby playing a role in intervening in the development of refractive errors. The second lens 202 on the lenslet 20 causes the light to form a maximized diffuse plaques on the retina, and there is a correlation between the size of the diffuse plaques and the intervention in the development of refractive errors; by changing the lenslet structural parameters of the second lens 202, the size of the diffuse plaques can be effectively controlled, and the stimulation intensity of the blurred state signal can be adjusted.

Further, the combination of the first lens 201 and the first noumenon 101 to form defocus means that the interaction between them will cause the focal point of the light to deviate from the ideal focal point position. In a specific position or state, the focal point of the eyeglass lens will be deliberately deviated to produce a specific visual effect. The setting of the first lens 201 can change the refraction path of the light, thereby changing the focal point position, and can be used to blur or adjust the focal point of the eyeglass lens to meet different visual needs. The combination of the second lens 202 and the first noumenon 101 to form a larger diffuse plaques reduces the visual quality by blurring the imaging so as to achieve a specific optical effect.

In some embodiments, referring to FIG. 1, the primary lens 10 also has a clear vision zone 200, and the primary lens 10 includes a second noumenon 102 within the clear vision zone 200; the modulation zone 100 surrounds the clear vision zone 200, and the second noumenon 102 is connected to the first noumenon 101; the center of the clear vision zone 200 coincides with the optical center 103 of the primary lens 10, the clear vision zone 200 is within a region 3-6 mm away from the optical center, and the modulation zone 100 is within a region 3-35 mm away from the optical center; among them, the area of the modulation zone 100 is S₁, and the projected area of the lenslet 20 within the modulation zone 100 along the direction perpendicular to the first noumenon 101 is S₂, satisfying: 0.5≤S₂/S₁≤0.8.

It can be understood that when the range of 0.5≤S₂/S₁≤0.8 is satisfied, it indicates that the lenslet 20 has a higher filling ratio within the modulation zone 100, due to the existence of the lenslet 20, the propagation path and refraction characteristics of the light can be changed, thereby realizing the balanced distribution of various stimulation signals. In addition, the sufficient area proportion combined with the balanced distribution of the three stimulation signals enables the unclarity visual stimulation signals to be more perceived by the peripheral retina, and at the same time, it can also ensure that the decrease in visual quality is within a reasonable range and control the risk of discomfort when wearing glasses.

Further, when the clear vision zone 200 is within the region 3 mm to 6 mm away from the optical center, the setting of this range is to ensure that when the human eye looks straight ahead or sweeps, the light beam of the peripheral visual field of the retina can pass through the area of the lenslet 20, so that the human eye can be stimulated by unclarity correction signals to intervene in the development of myopia and hyperopia.

In some embodiments, the refractive power of the first lens 201 is P₁D, the refractive power of the second lens 202 is P₂D, and the refractive power of the first noumenon 101 is P₀D, satisfying: 2.5≤|P₁-P₀|1≤8.0. For example, the value of |P₁-P₀| can be at least one of 2.5, 3.0, 3.5, 4.0, 4.5, 5.0, 5.0, 6.0, 6.5, 7.0, 7.5, 8.0 or a range between at least two of them. When the range of 2.5≤|P₁-P₀| 8.0 is satisfied, it is suitable to the combination of the first lens 201 and the primary lens 10 to form defocus; the lower limit value can ensure that the light passing through the first lens 201 will not be interfered by the peripheral defocus of the naked eye retina and will always form an image in front of or behind the retina, thereby forming a true myopia or hyperopia defocus, and the upper limit value can avoid forming a deep defocus and destroying the effect of peripheral defocus.

In some embodiments, the second lens 202 further satisfies: 10≤|P₂-P₀≤32. For example, the value of |P₂-P₀| can be at least one of 10, 11, 12, 13, 14, 15, 16, 17, 18, 19, 20, 21, 22, 23, 24, 25, 26, 27, 28, 29, 30, 31, 32 or a range between at least two of them. When the range of 10≤|P₂-P₀|32 is satisfied, it is suitable for the combination of the second lens 202 and the primary lens to form a diffuse plaques. Among them, the upper limit value can avoid generating an overly large diffuse plaques that makes it difficult for the wearer to adapt, and the lower limit value can ensure the formation of a diffuse plaques stimulation signal with sufficient intensity.

In some embodiments, the first lens 201 and the second lens 202 further satisfy: 8≤|P₂-P₁|≤30. For example, the value of |P₂-P₁| can be at least one of 8, 9, 10, 11, 12, 13, 14, 15, 16, 17, 18, 19, 20, 21, 22, 23, 24, 25, 26, 27, 28, 29, 30 or a range between at least two of them. When the range of 8≤P₂-P₁|≤30 is satisfied, it is suitable for the first lens 201 and the second lens 202 to simultaneously provide two stimulation signals, namely peripheral defocus stimulation signal and blurred diffuse plaques stimulation signal, and maintain the aesthetics of the lens. Among them, the upper limit value can avoid a large visual difference between the second lens 202 and the first lens 201, making them visually distinguishable, and the lower limit value can ensure the effective separation of the two lenses in function, thereby generating two different stimulation signals.

In some embodiments, the sagittal height of the first lens 201 is H₁ μm, and the sagittal height of the second lens 202 is H₂ μm, satisfying: 2≤H₂/H₁≤20; and 0.5≤H₁≤5; 1≤H₂≤10. For example, the value of H₂/H₁ can be at least one of 2, 3, 4, 5, 6, 7, 8, 9, 10, 11, 12, 13, 14, 15, 16, 17, 18, 19, 20 or a range between at least two of them. It can be understood that the sagittal height refers to the height of the vertex of the lens surface relative to the surface of the primary lens, and the sagittal height can be used to indirectly describe the shape and curvature of the lens, as well as the focusing ability of the lens on light. When the above ranges are satisfied, it can be ensured that the diffuse plaques formed by the combination of the second lens 202 and the primary lens is significantly larger than the diffuse plaques formed by the combination of the first lens 201 and the primary lens, so that the combination of the second lens 202 and the primary lens mainly provides a blurred diffuse plaques stimulation signal, while the combination of the first lens 201 and the primary lens mainly provides a peripheral defocus stimulation signal, and the upper limit values of the sagittal heights of the two lenslets ensure that the two lenslets are basically invisible visually.

Among them, the sagittal height of the second lens 202 does not exceed 10 μm, which can make the lenslet basically invisible visually and maintain the aesthetics of the lens.

In some embodiments, the first noumenon 101 and the second noumenon 102 are integrally molded.

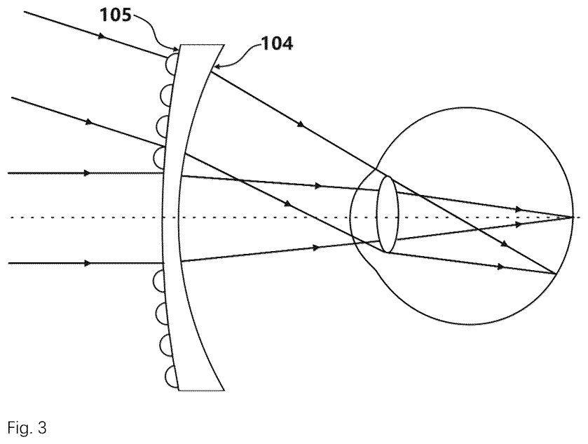

In some embodiments, referring to FIG. 3, the primary lens 10 includes a second optical surface 104 on the eye-facing side and a first optical surface 105 facing away from the second optical surface 104; among them, the lenslet 20 is located on the first optical surface 105, or the lenslet 20 is located on the second optical surface 104, or, the lenslet 20 is located between the first optical surface 105 and the second optical surface 104.

In some embodiments, the shape of the first optical surface 105 and/or the second optical surface 104 is selected from at least one of spherical surface, aspherical surface, and freeform curved surface; including providing aberration correction or precise compensation function for peripheral hyperopic defocus.

In some embodiments, the shape of the first lens 201 is selected from at least one of spherical surface, aspherical surface, toroidal curved surface, cylindrical surface, and freeform curved surface.

In some embodiments, the shape of the second lens 202 is selected from at least one of spherical surface, aspherical surface, toroidal curved surface, cylindrical surface, and freeform curved surface.

In some embodiments, the diameter of the first lens 201 and/or the second lens 202 is in the range from 0.1 mm to 2 mm; for example, the diameter can be any one of 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm or a range between any two of them. It can be understood that the diameters of the first lens 201 and the second lens 202 can be optionally equal, firstly, it is to facilitate the uniform distribution of the lenslet, so that the regions generating various stimulation signals remain generally balanced; secondly, it is to ensure that when the human eye looks straight ahead or sweeps, the full-aperture light beam of the peripheral visual field of the retina can completely cover the first noumenon 101 on the lenslet, ensuring that the human eye has more clear vision signal stimulation, making it easier for the wearer to adapt, and the full-aperture light beam of the peripheral visual field of the retina can basically or completely cover one first lens 201 and an adjacent second lens 202, ensuring that the human eye can be stimulated by two unclarity correction signals to intervene in the development of myopia and hyperopia.

In some embodiments, the first lens 201 and the second lens 202 are circular convex lenses or circular concave lenses.

In some embodiments, in case where the first lens 201 and the second lens 202 are circular convex lenses or circular concave lenses and are arranged on the first optical surface 105, the first lens 201 and the second lens 202 are more convex or more concave relative to the first optical surface 105; in case where the first lens 201 and the second lens 202 are circular convex lenses or circular concave lenses and are arranged on the second optical surface 104, the first lens 201 and the second lens 202 are more convex or more concave relative to the first optical surface 105.

In some embodiments, the sum of the diameters of the first lens 201 and the second lens 202 is less than or equal to the pupil diameter; the diameter of the human eye pupil is generally in the range from 3 mm to 6 mm.

In some embodiments, the connection mode of the first lens 201 and the second lens 202 is tangential at the edges.

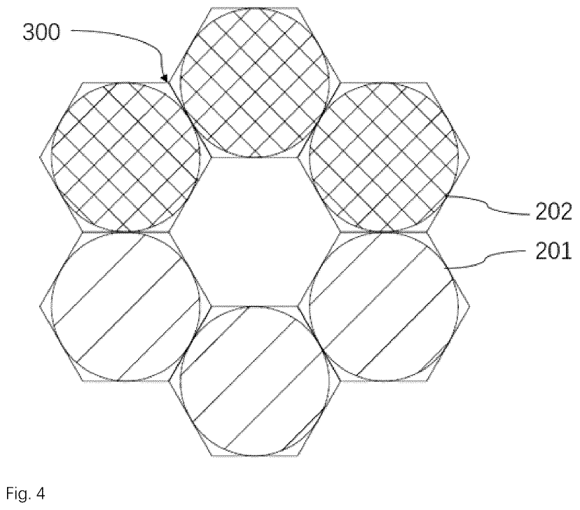

In some embodiments, the first lens 201 and the second lens 202 are connected alternately in sequence, specifically referring to FIG. 2; of course, in some other embodiments, the first lens 201 and the second lens 202 can also be spaced apart, specifically referring to FIG. 4. Among them, in case where the first lens 201 and the second lens 202 are connected alternately in sequence, it can further enable the balanced distribution of the three generated stimulation signals, so that the unclarity visual stimulation signals are more perceived by the peripheral retina, and ensure that the decrease in visual quality is within a reasonable range.

In some embodiments, the normal of the vertex of the first lens 201 or the second lens 202 faces the center of curvature of the surface of the primary lens, which can ensure the coaxiality of the light passing through the lenslet and the light of the first noumenon 101.

In some embodiments, the diffuse plaques produced by light passing through the second lens 202 on the retina has a first RMS radius value, and the diffuse plaques produced by light passing through the first lens 201 on the retina has a second RMS radius value, and the first RMS radius value is greater than the second RMS radius value. When the above relationship is satisfied, two unclarity stimulation signals can be generated, the diffuse plaques formed by the combination of the second lens 202 and the primary lens is significantly larger than the diffuse plaques formed by the combination of the first lens 201 and the primary lens, the larger diffuse plaques is the blurred diffuse plaques stimulation signal, and the smaller diffuse plaques is the peripheral defocus stimulation signal, the two unclarity signals exist concurrently and intervene in the development of refractive errors in different ways.

In some embodiments, referring to FIGS. 1 and 2, the lenslet 20 exists in such a way that regular hexagonal grids are divided in the modulation zone 100, and the first lens 201 and the second lens 202 are arranged in the form of inscribed circles within the regular hexagonal grids, the first lens 201 and the second lens 202 exist in the form of interconnected connection and respectively have the functions of peripheral defocus or diffuse plaques modulation. The second lens 202 is closely arranged with the adjacent first lens 201 and is tangent to the boundary, therefore, the eyeglass lens concurrently provides three optical stimulation signals, namely one for clear vision, one for peripheral defocus, and one for blurred diffuse plaques, through this surface lenslet, and ensures that each signal is adjacent to and connected with at least two other different signal units, thereby providing the lens wearer with continuous and balanced multiple peripheral retinal stimulation signals.

In some embodiments, this embodiment also provides a method for designing the lenslet eyeglass lens, including the following steps:
Provide the primary lens 10, the primary lens 10 has a clear vision zone 200 and the modulation zone 100, the modulation zone 100 surrounds the clear vision zone 200, the primary lens 10 includes the first noumenon 101 within the modulation zone 100; arrange grids 300 in an array in the modulation zone 100, and the grids 300 are connected to each other;
Provide a first lens 201, the first lens 201 is arranged in the grid 300 and is connected to the first noumenon 101, used to create defocus when combined with the first noumenon 101;
Provide a second lens 202, the second lens 202 is arranged in the grid 300 and is connected to the first noumenon 101, used to create a diffuse plaques when combined with the first noumenon 101;
Among them, the first lens 201 and the second lens 202 are connected and expose a part of the first noumenon 101, so that the modulation zone 100 can concurrently generate a clear visual signal, a defocus signal, and a diffuse plaques modulation signal.

It can be understood that the design method of this application can adjust the proportion of various signals in a certain area in a convenient and evenly distributed manner through the grid array layout, within the range of the pupil sweep, the area of various signal stimulations received by each area remains approximately constant or a certain signal is increased according to a certain proportion, the formed lenslet form can make the eyeglass frame perfectly simulate a similar state. Once the difference in the size of the diffuse plaques of two different lenslets reaches a certain proportion, the effect that the optical signals of different lenslets are always in a competitive existence on the retina can be achieved.

In some embodiments, the grids 300 are at least one of regular polygon, circle, or ellipse.

In some embodiments, more preferably, the grids 300 are regular hexagons, and the first lens 201 and the second lens 202 are set in the shape of inscribed circles within the regular hexagons.

In some embodiments, the step of providing the primary lens 10 further includes:
determining the shape parameters of the primary lens 10 according to the prescription for glasses and the refractive index of the material of the primary lens, and establishing the primary lens model;
The step of providing the first lens 201 further includes: determining the shape parameters and the diameter of the first lens 201, determining the position of the first lens 201 in the modulation zone 100 according to the layout of the grids 300, and forming the first lens 201 on the surface of the primary lens model;
The step of providing the second lens 202 further includes: determining the shape parameters and the diameter of the second lens 202, determining the position of the second lens 202 in the modulation zone 100 according to the layout of the grids 300, and form the second lens 202 on the surface of the primary lens model.

In some embodiments, the step of determining the shape parameters of the second lens 202 further includes:
Conduct an optical simulation on the primary lens model with the first lens 201 and the second lens 202 formed on its surface to obtain the size and shape of the diffuse plaques generated by the light of the maximum off-axis field of view of the second lens 202 on the retina, so as to determine the RMS radius value of the diffuse plaques;
Keep the diameter of the second lens 202 unchanged, gradually change the single-sided mean power or the sagittal height of the second lens 202, and establish the relationship between the single-sided mean power or the sagittal height and the RMS radius value of the diffuse plaques through regression analysis;
Based on the RMS radius value of the diffuse plaques added for the lens wearer and combined with the relationship, obtain the single-sided mean power or the sagittal height of the second lens 202 to acquire the shape parameters of the second lens.

In some embodiments, the second lens 202 for the blurred diffuse plaques is signal-modulated by the following design method: after configuring the lenslet with the function of modulating the diffuse plaques on the retinal image plane, setting the pupil diameter, the lens-eye distance, and the axial length of the eye, use the evaluation method of the plaques diagram to confirm the size and shape of the diffuse plaques of its imaging on the retina, by changing the structural parameters of the lenslet, establish the empirical formula of the single-sided mean power or the sagittal height of the second lens and the RMS radius of the diffuse plaques under different lenslet shapes including spherical surface, aspherical surface, and freeform curved surface in a regression analysis manner.

In some embodiments, this embodiment provides a method for designing the lenslet eyeglass lens, including the following steps:
S1. Calculate the shape parameters of the first optical surface 105 and the second optical surface 104 of the primary lens according to the prescription for glasses of the lens wearer and the refractive index of the selected lens material and then determine the positional relationship between the first optical surface 105 and the second optical surface 104 according to the selected diameter and central thickness of the eyeglass lens, insert the determined lens in front of the ideal eye model; then, take the vitreous noumenon thickness of the ideal eye model as a variable, optimize the lens-eye model corresponding to the myopic form;
S2. Calculate the shape, radial position, and spherical center coordinates of the first lens 201 in the lenslet 20 according to the need of peripheral defocus. Firstly, determine the diameter D₁ of the second noumenon 102 in the clear vision zone 200. Then, select the shape of the first lens 201. Obtain the shape parameters of the first lens 201 according to the absolute value of the difference between the single-sided mean power of the first lens 201 and the mean power of the first noumenon 101 being 2.5-8 diopters, and select the size of D₂ according to the range of the radial diameter D₂ of the first lens 201 being 0.8 mm to 2 mm. Finally, calculate the structural parameters of the regular hexagonal grid 300: Specifically, taking the selected diameter D₁, the radial diameter D₂ of the first lens 201, and the radial diameter of the second lens 202 being equal to that of the first lens 201 as constraints, combined with the geometric relationship of the regular hexagonal lenslet array, determine the radial distance h from the center of the first lens 201 at each position on the lens to the optical axis of the lens, and then combined with the radius of curvature r₁ of the lenslet and the constraint condition that the normal of the vertex of the first lens 201 faces the center of curvature of the surface of the first noumenon 101 at that position, determine the position of the reference point (the modeling reference such as the spherical center or the focus, etc.,) of the first lens 201 at each position;
S3. Conduct three-dimensional modeling according to the calculation results of step S2, and add the first lens 201 composed of the lenslet array in the shape of an inscribed circle of a regular hexagon on the front surface of the lens model. Insert the model into the lens-eye model of the myopic form, and verify the peripheral defocus function in front of the retina of the off-axis light passing through the first lens 201 through optical simulation;
S4. Calculate the structural parameters of the second lens 202 according to the need of diffuse plaques regulation. Determine the shape, initial single-sided mean power or sagittal height, and the radial diameter D₃ of the second lens 202, solve the radial distance h₁ from the center of the second lens 202 at each position to the optical axis of the first noumenon 101 with the radial diameter of the second lens 202 and the arrangement of the second lens 202, and then according to the shape parameters of the second lens 202 and the condition that the normal of the vertex of the second lens 202 faces the center of curvature of the surface of the first noumenon 101 at that position, determine the position of the reference point (the modeling reference such as the spherical center or the focus, etc.,) of the second lens 202 at each position;
S5. According to the calculation results of step S4, through three-dimensional modeling, add the second lens 202 composed of the lenslet array in the shape of an inscribed circle of a regular hexagon on the lens model of step S3, insert the built model into the lens-eye model of the myopic form, and record the size and shape of the diffuse plaques generated on the retina by the light of the maximum off-axis field of view passing through the second lens 202 through optical simulation;
S6. Keep the radial diameter D₃ of the second lens 202 unchanged, gradually change the single-sided mean power or the sagittal height of the second lens 202, repeat steps S4 and S5, through modeling and optical simulation, record the size and shape changes of the diffuse plaques on the retina with the change of the single-sided mean power or the sagittal height of the second lens 202 under the maximum off-axis field of view; establish the empirical formula of the single-sided mean power or the sagittal height (independent variable x) and the RMS radius (dependent variable y) of the diffuse plaques through linear fitting: y=f (x);
S7. According to the RMS radius value of the diffuse plaques added for the lens wearer, based on the empirical formula of step S6, solve the single-sided mean power or the sagittal height of the second lens 202, and then obtain the structural parameters of the second lens 202.

In some embodiments, in step S2, the radial diameter of the second lens 202 is the same as that of the first lens 201, and the sum of the diameters of any first lens 201 and its adjacent second lens 202 does not exceed the pupil diameter.

In some embodiments, in step S4, a spherical surface is used as the initial shape of the lenslets in the form of inscribed circles of regular hexagons for the first lens 201 and the second lens 202.

In some embodiments, the eyeglass lens can be cast or injection molded using a metal mold, or cast using a glass mold into the required prescription power or a semi-finished product, the semi-finished product is then processed on the inner surface in a workshop to obtain the required prescription power. In some embodiments, the eyeglass lens can also be made into the required prescription power or a semi-finished product using metal and glass molds through a UV light curing process, the semi-finished product is then processed on the surface of the blank to make the eyeglass lens required by the wearer, or an eyeglass lens or an eyeglass lens blank made through a laminating process.

In some embodiments, the material of the primary lens includes polymeric materials or inorganic non-metallic materials. Among them, polymeric materials include thermoplastic resins or thermosetting resins, and inorganic non-metallic materials include glass, etc. Thermoplastic resins include polycarbonate or polymethyl methacrylate; thermosetting resins include any one of acrylic resins, episulfide resins, thiourethane resins, allyl resins, and polyurethanes.

In some embodiments, a coating film is formed on the surface of at least one side of the primary lens. The coating film includes a transparent coating film that increases the light transmittance of the lens, a hard coating film that increases the durability of the lens, a reflective film that blocks harmful light, an anti-reflective and anti-refraction film that realizes the visibility of imaging, a polarizing film with a color-changing function, or other color-changing films doped with materials sensitive to ultraviolet rays, etc. The coating film itself can have different colors, and the visible color under reflection can be green, blue, yellow, purple, etc., or other colors.

In some embodiments, the eyeglass lens is directly prepared by a mold, and the mold can include an upper mold base and a lower mold base, the working surface of the upper mold base is a concave surface, which is respectively used to form the first optical surface and the second optical surface.

In some embodiments, after combining the eyeglass lens obtained through the above process with an eyeglass frame, glasses can be further obtained, and the shape of the eyeglass lens can be circular, square, oval-like, or other irregular structures. It should be noted that the shape of the eyeglass lens is approximately the above shapes, and is not limited to perfect geometric shapes.

To enable those skilled in the art to clearly understand the above implementation details and operations of this application, and to significantly demonstrate the advanced performance of the lenslet eyeglass lens and its design method in the embodiments of the present application, the above technical solutions are illustrated through multiple embodiments below.

### Embodiment 1

Assume that the prescription for the lens wearer is S-3.00D, set the diameter of the lens to 60 mm, the refractive index of the material to 1.56, the central thickness of the lens to 1.3 mm, and the shape to be a meniscus lens, the front surface corresponds to the first optical surface, and the rear surface corresponds to the second optical surface; a method for designing the lenslet eyeglass lens is provided, including the following steps:

St11: According to the prescription for glasses of the lens wearer −3D, set the mean power of the front surface of the lens to 2 diopters (abbreviated as D), then the mean power of the vertex of the rear surface is −5 diopters; then, combined with the refractive index of the lens material, calculate the spherical radii R₁ and R₂ of the primary lens 10 of the lens. The structural data of the obtained primary lens 10 are shown in Table 1

TABLE 1

| | Front surface/Spherical | | Rear surface/Spherical | | |
|---|---|---|---|---|---|
| Lens | surface | | surface | | Refractive |
| Diameter | mean | Radius | mean | Radius | index of the |
| D/mm | power/D | R₁/mm | power/D | R₂/mm | material |
| 60 | 2 | 280 | −5 | 112 | 1.56 |

St12: Select the Liou ideal eye model, insert the lens in front of the ideal eye model, set the distance between the lens and the front surface of the cornea to 12 mm, set the diameter of the ideal eye pupil to 5 mm, the system wavelength to 0.55 μm, and the full field of view to ±14°. Taking the vitreous noumenon thickness of the ideal eye model as a variable, optimize the corresponding lens-eye model in the myopic form. Its optical system is shown in FIG. 3.

St21: With the constraint that the first lens 201 and the second lens 202 are not arranged in the central area of the front surface of the lens with a diameter range of at least 6 mm, and the diameter of the central area of the front surface is between 6 mm and 12 mm, determine the diameter D₁ of the second noumenon 102 in the clear vision zone 200 to be 9.8 mm.

St22: Determine that the first lens 201 is a convex lens with a spherical surface shape, select 3D from the range of 2.5-8 diopters for the absolute value of the difference between the single-sided mean power of the first lens 201 and the mean power of the front surface, then the single-sided mean power of the first lens 201 is 5D, based on these, calculate the radius of curvature r₁ of the first lens 201. The diameter of the pupil of a general human eye is in the range from 3 mm to 6 mm, to meet the requirement that the full-aperture light beam of the peripheral visual field of the retina can basically or completely cover one first lens 201 and an adjacent second lens 202, select the radial diameter D₂ of the convex lens to be 1.2 mm, the optical structure data of the first lens 201 are shown in Table 2.

TABLE 2

| Difference from the | | Radius of | Radial |
|---|---|---|---|
| mean power of the | mean | curvature | diameter |
| front surface/D | power/D | r₁/mm | D₂/mm |
| 3 | 5 | 112 | 1.2 |

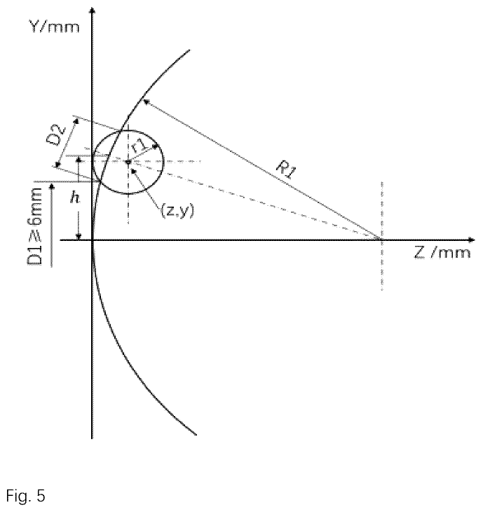

St23: Calculate the structural parameters of the regular hexagonal lenslet array composed of alternately distributed first lenses and second lenses outside the central area of the front surface. The schematic diagram of the positional relationship between the first lens 201 and the exposed first noumenon 101 within the YOZ optical axis section is shown in FIG. 5, here, the Z-axis is the optical axis, to conveniently mark the center of the first lens sphere, a complete circle is drawn on the figure according to the radius r₁. In fact, only the part of the convex lens protruding from the first noumenon 101 exists on the actual lens. Since the radial diameter of the first lens 201 is the same as that of the second lens 202 and also the same as the radial diameter of the first noumenon 101 exposed at the center of the lenslet, the center distance between any first lens 201 and its radially adjacent second lens 202 is approximately equal to 3.6 mm, thus, based on the selected diameter D₁ and the radial diameter D₂ of the first lens 201, the radial distance h from the center of the first lens 201 to the optical axis within the YOZ section can be first determined (h is the vertical distance from the intersection point of the normal of the convex lens vertex and the spherical surface of the first noumenon 101 to the optical axis). According to the radial distance h from the center of the first lens 201 to the optical axis and the radius of curvature r1 of the lenslet, plus the constraint condition that the direction of the normal of the vertex of the first lens 201 should face the center of the surface curvature of the first noumenon 101 at that position, the spherical center positions (z, y) of each first lens 201 on the YOZ section can be calculated, the above calculation data are shown in Table 3.

TABLE 3

| | | |
|---|---|---|
| | Radial | Center of Sphere |
| Serial | Distance | Coordinates |

| Number | h/mm | z/mm | y/mm |
|---|---|---|---|
| 1 | 5.5 | 112.031 | 3.3000 |
| 2 | 9.1 | 112.088 | 5.4600 |
| 3 | 12.7 | 112.172 | 7.6201 |
| 4 | 16.3 | 112.284 | 9.7801 |
| 5 | 19.9 | 112.424 | 11.9401 |
| 6 | 23.5 | 112.592 | 14.1001 |

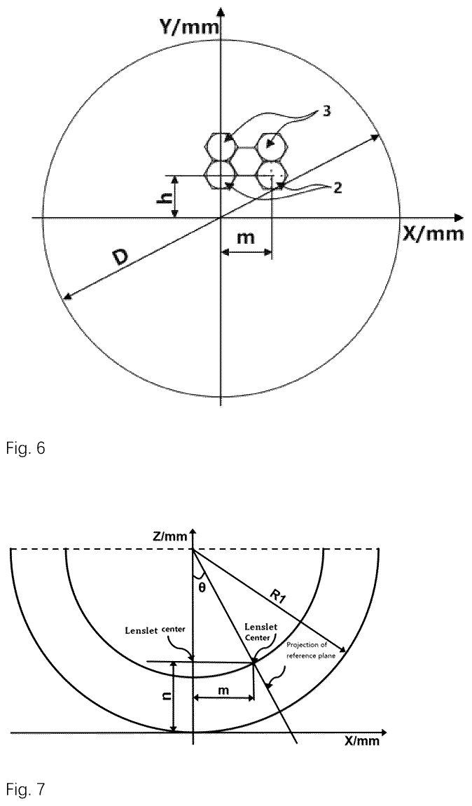

According to the arrangement of the regular hexagonal lenslet array, the positional relationship between the first lens 201 with serial number 1 on the YOZ optical axis section in Table 3 and the nearest first lens 201 in the horizontal direction can be obtained, and the distance m from the center of this nearest first lens 201 to the Y-axis can be calculated (the center of the first lens 201 is defined as the intersection point of the normal of the lenslet vertex and the spherical surface of the first noumenon 101), as shown in FIG. 6; then, according to the needs of modeling, a reference plane is made through the normal of the vertex of this lenslet and perpendicular to the XOZ plane, and it is projected onto the XOZ plane, as shown in FIG. 7, the distance from the first lens 201 to the Z-axis on the figure is set as n, then, according to the spherical radius R₁ of the exposed first noumenon 101 and m, the included angle θ between this reference plane and the Z-axis can be calculated, the calculation formula is as follows:

$$θ = {tan}^{- 1} ( \frac{m}{{R}_{1} - n} )$$

A new coordinate system can be established using this reference plane, and the positional relationship between the first lens 201 and the exposed first noumenon similar to that in FIG. 5 can be drawn, the spherical center position (z, y) of the first lens 201 on this reference plane obtained according to this positional relationship is the same as the spherical center coordinate data of the first lens 201 with the same radial distance h obtained from Table 3. By repeating the above process, the included angle θ between the reference planes of all the first lenses 201 with the same radial distance h and the X-axis can be calculated; according to the above method, the θ angles of the reference planes of all the first lenses 201 with other radial distances whose serial numbers are 2-6 in Table 3 can be calculated in turn. Similarly, the θ angles of the reference planes and the spherical center positions on the reference planes of the first lenses 201 with other radial distances not listed in Table 3 can also be calculated using the above method.

St3: Conduct three-dimensional modeling according to the calculation results of steps St21-St23, and add the first lens composed of the lenslet array in the shape of an inscribed circle of a regular hexagon on the front surface of the exposed first noumenon of the lens model.

St4: Calculate the structural parameters of the second lens 202 in the lenslet according to the need of diffuse plaques regulation. Select a spherical surface as the shape of the lenslet in the form of an inscribed circle of a regular hexagon for the second lens 202; to obtain a larger diffuse plaques, determine the initial single-sided mean power of the second lens 202 to be 15D, the radial diameter of the second lens 202 is the same as that of the first lens 201, which is 1.2 mm. Solve the radial distance from the center of the second lens 202 at each position to the optical axis of the exposed first noumenon 101 with the radial diameter and the arrangement of the second lens 202. Combined with the radius of curvature of the second lens 202 and the condition that the normal of the vertex of the second lens 202 faces the center of the curvature of the surface of the first noumenon 101 at that position, determine the spherical center position of the second lens 202 on the reference plane. The solving method is the same as that used for the first lens 201.

St5: According to the calculation results of step St4, through three-dimensional modeling, add the second lens 202 composed of the lenslet array in the shape of an inscribed circle of a regular hexagon on the lens model of step St3, reinsert the built model into the lens-eye model of the myopic form, and record the size and shape of the diffuse plaques generated on the retina by the light of the maximum off-axis field of view passing through the second lens 202 through optical simulation.

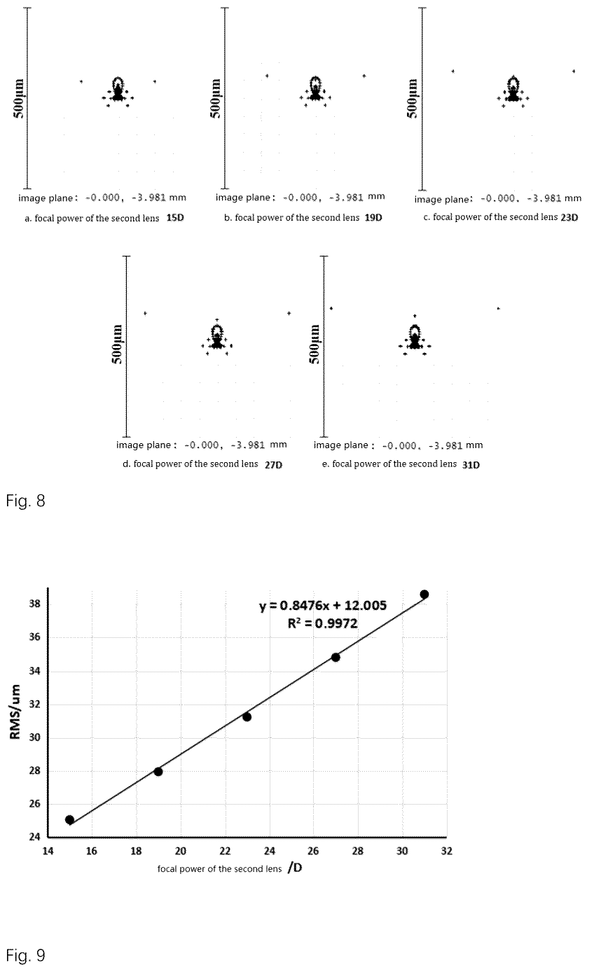

St6: Keep the radial diameter of the second lens 202 unchanged, increase the single-sided mean power of the second lens 202 at an equal power interval of 4D, and with the constraint that the sagittal height of the second lens 202 does not exceed 10 micrometers, repeat steps St4 and St5, through modeling and optical simulation, record the size and shape of the diffuse plaques on the retina with the increase of the single-sided power of the second lens under the maximum off-axis field of view, the RMS data of the diffuse plaques radius are shown in Table 4, and the shape of the diffuse plaques is shown in FIG. 8.

TABLE 4

| Serial | Power of | Sagittal Height of | |
|---|---|---|---|
| Number | lenslet/D | lenslet/um | RMS/um |
| 1 | 15 | 4.822 | 25.040 |
| 2 | 19 | 6.108 | 27.917 |
| 3 | 23 | 7.394 | 31.200 |
| 4 | 27 | 8.680 | 34.775 |
| 5 | 31 | 9.967 | 38.562 |

From all five results, a scatter plot of the single-sided mean power of the second lens 202 and the RMS radius of the diffuse plaques of the lens-eye system can be obtained, as shown in FIG. 9, through linear fitting, an empirical formula of the single-sided mean power of the second lens 202 (independent variable x) and the RMS radius of the diffuse plaques (dependent variable y) is established. The empirical formula is as follows:

y=0.8476x+12.005;

From this empirical formula, it can be known that the shape parameters of the second lens 202 will affect the size of the diffuse plaques on the retina. The single-sided mean power of the second lens 202 is larger, the RMS radius value of the generated diffuse plaques is also larger, showing a linear positive correlation between the two.

St7: According to the RMS radius value of the diffuse plaques added for the lens wearer, based on the empirical formula in step St6, solve for the single-sided mean power of the second lens 202, and then obtain the final shape parameters of the second lens 202.

In order to compare the degree of the diffuse plaques generated by the second lens 202 compared to that of the first lens 201, replace the second lens 202 with the structural parameters of the first lens 201, remodel and conduct optical simulation again to obtain the RMS radius value of the diffuse plaques generated on the retina at the maximum field of view, which is the value corresponding to the 5D power in Table 5, then compare it with the RMS radius value of the diffuse plaques in Table 4 to calculate the increase rate. It can be seen from Table 5 that when constructing the second lens 202 with the power of the first lens 201, due to the smaller power, the diffuse plaques is also relatively small; when the power of the second lens 202 increases from 15D to 31D, the RMS value of its diffuse plaques radius increases by 21% to 86.3% compared to the result of constructing the second lens 202 with the 5D power, therefore, if the size of the diffuse plaques is to be significantly increased, the structural parameters of the second lens 202 need to be redesigned.

TABLE 5

| | | Increase rate of RMS |
|---|---|---|
| Focal power of the | | (Compared with the |
| second lens 202/D | RMS/um | result of 5D power) |
| 5 | 20.696 | |
| 15 | 25.040 | 21.0% |
| 19 | 27.917 | 34.9% |
| 23 | 31.200 | 50.8% |
| 27 | 34.775 | 68.0% |
| 31 | 38.562 | 86.3% |

### Embodiment 2

Assume that the prescription for the lens wearer is S-3.00D, set the diameter D of the lens to 60 mm, the refractive index of the material to 1.56, the central thickness of the lens to 1.3 mm, and the shape to be a meniscus lens; the front surface corresponds to the first optical surface, and the rear surface corresponds to the second optical surface; the method for designing the lenslet eyeglass lens is provided, including the following steps:

Steps St11, St12, St21-23, and St3 are exactly the same as those in Embodiment 1.

St4: Calculate the structural parameters of the second lens 202 in the lenslet according to the need of diffuse plaques regulation; select an aspherical surface as the shape of the lenslet in the form of an inscribed circle of a regular hexagon for the second lens 202; to obtain a larger diffuse plaques, select an appropriate initial sagittal height of the second lens 202; and the radial diameter of the second lens 202 is the same as that of the first lens 201; solve the radial distance from the center of the second lens 202 at each position to the optical axis of the exposed first noumenon 101 with the radial diameter and the arrangement of the second lens 202, after that, combined with the sagittal height of the second lens 202 and the direction of the normal of the vertex of the second lens 202 facing the center of the surface curvature of the first noumenon 101 at that position, the vertex (z1, y1) and the focus position (z2, y2) of the parabolic lenslet of the second lens 202 on each reference plane can be calculated; the specific process is as follows:

St41: Select the initial sagittal height of the second lens 202 to be 5 micrometers, select the shape of the aspherical lenslet to be a parabolic surface, and the radial diameter of the second lens 202 is the same as that of the first lens 202, the optical structure data of the second lens 202 are shown in Table 6.

TABLE 6

| | Sagittal Height | | Vertex |
|---|---|---|---|
| | Protruding from | Radial | Curvature |
| Surface Shape | the Front Surface/μm | Diameter/mm | Radius/mm |
| Parabolic surface | 5 | 1.2 | 31.899 |

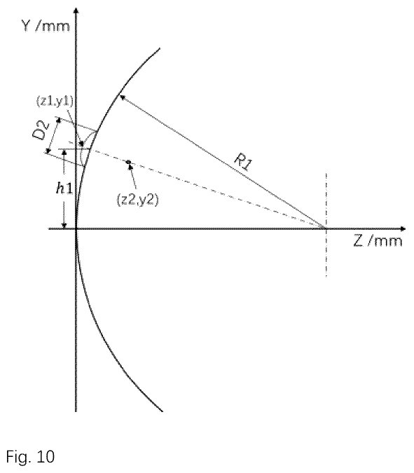

St42: Solve the radial distance h₁ (h₁ is the vertical distance from the intersection point of the normal of the parabolic lenslet vertex and the spherical surface of the first noumenon 101 to the optical axis) from the center of the second lens 202 at each position to the optical axis of the exposed first noumenon 101 and the reference point of the lenslet with the radial diameter and the arrangement of the second lens 202. Firstly, solve the radial distance h₁ from the center of the second lens 202 to the optical axis of the exposed first noumenon 101 and the reference point on the YOZ optical axis section. Since the radial diameters of the first lens 201 and the second lens 202, as well as the radial diameter of the exposed first noumenon 101 are all the same, the center distance between the second lens 202 and the radially adjacent first lens 201 on the YOZ optical axis section is approximately equal to 1.2 mm, and the center distance between the second lens 202 and the radially adjacent second lens 202 is approximately equal to 3.6 mm, thus, the radial distance h₁ from the center of the second lens 202 to the optical axis of the exposed first noumenon 101 on the YOZ optical axis section is obtained; then, based on the sagittal height of the second lens 202 and the direction of the normal of the vertex of the second lens 202 facing the center of the surface curvature of the first noumenon 101 at that position, calculate the vertex (z1, y1) and the parabolic focus position (z2, y2) of each parabolic lenslet of the second lens 202 on the YOZ optical axis section. The positional relationship between the parabolic lenslet of the second lens 202 and the first noumenon 101 on the YOZ optical axis section is shown in FIG. 10. The vertex and focus coordinate data of the parabolic lenslet of the second lens 202 on the YOZ plane obtained above are shown in Table 7.

TABLE 7

| | | |
|---|---|---|
| Radial distance | Vertex coordinates | Focus coordinates |

| h₁/mm | z1/mm | y1/mm | z2/mm | y2/mm |
|---|---|---|---|---|
| 6.7 | 0.075 | 6.700 | 16.020 | 6.318 |
| 10.3 | 0.185 | 10.300 | 16.123 | 9.713 |
| 13.9 | 0.340 | 13.900 | 16.270 | 13.108 |
| 17.5 | 0.542 | 17.500 | 16.461 | 16.503 |
| 21.1 | 0.791 | 21.100 | 16.695 | 19.898 |

The method for solving the included angle θ between the reference plane (this reference plane passes through the normal of the parabolic vertex and is perpendicular to the XOZ plane) of the parabolic lenslet of the second lens 202 at other positions not on the Y-axis and the YZ plane is the same as the method for solving the first lens 201 not on the Y-axis; according to this method, the vertex (z1, y1) and the focus position (z2, y2) of the parabolic lenslet of the second lens 202 at other positions not on the Y-axis on the reference plane can be obtained.

St5: Conduct three-dimensional modeling according to the calculation results of step St4, add the second lens 202 composed of the lenslet array in the shape of an inscribed circle of a regular hexagon on the lens model of step St3, reinsert the built model into the lens-eye model of the myopic form, record the size and shape of the diffuse plaques generated on the retina by the light of the maximum off-axis field of view passing through the second lens 202 through optical simulation.

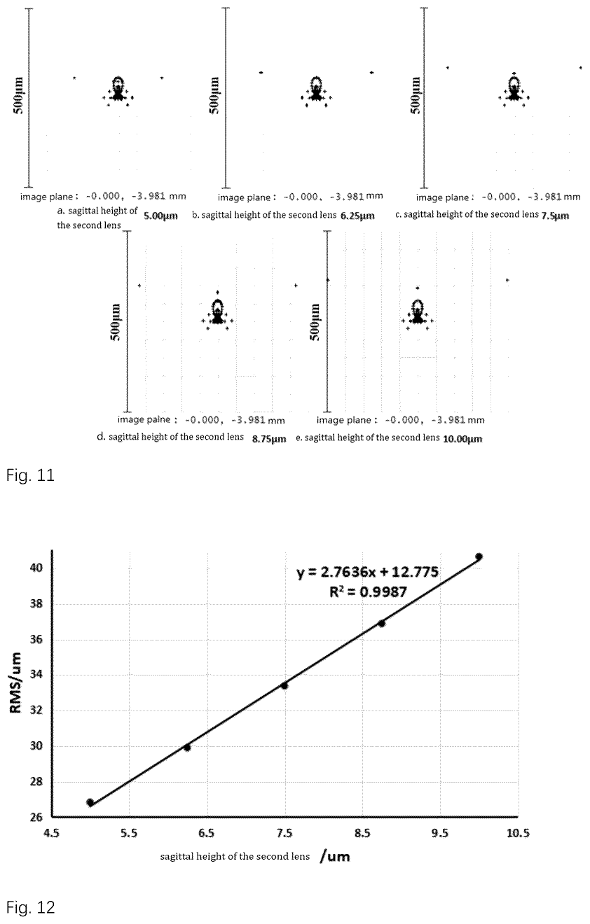

St6: Keep the radial diameter of the second lens 202 unchanged, and with the constraint that the sagittal height of the second lens 202 does not exceed 10 μm, increase the sagittal height of the lenslet of the second lens 202 to 10 μm at an equal sagittal height interval of 1.25 μm, repeat steps St4 and St5. Through modeling and optical simulation, record the size and shape of the diffuse plaques on the retina with the increase of the single-sided power of the second lens 202 under the maximum off-axis field of view, the RMS data of the diffuse plaques radius are shown in Table 8, and the shape of the diffuse plaques is shown in FIG. 11.

TABLE 8

| | Sagittal height | |
|---|---|---|
| Serial | of the second | |
| Number | lens 202/um | RMS/um |
| 1 | 5.00 | 26.823 |
| 2 | 6.25 | 29.880 |
| 3 | 7.50 | 33.350 |
| 4 | 8.75 | 36.847 |
| 5 | 10.00 | 40.612 |

From all five results, a scatter plot of the sagittal height of the second lens 202 and the RMS radius of the diffuse plaques can be obtained, as shown in FIG. 12, through linear fitting, an empirical formula of the sagittal height of the second lens 202 (independent variable x) and the RMS radius of the diffuse plaques of the lens-eye system (dependent variable y) is established, and the empirical formula is as follows:

$$y = 2.7636 x + 12.755 ;$$

From this empirical formula, it can be known that the shape parameters of the second lens 202 will affect the size of the diffuse plaques on the retina. When the sagittal height of the lenslet of the second lens 202 is larger, the RMS radius value of the generated diffuse plaques is also larger, showing a linear positive correlation between the two.

St7: According to the RMS radius value of the diffuse plaques added for the lens wearer, based on the empirical formula in step S6, solve for the sagittal height of the second lens 202, and then obtain the final shape parameters of the second lens 202.

In order to compare the degree of the diffuse plaques generated by the second lens 202 compared to that of the first lens 201, replace the second lens 202 with the structural parameters of the first lens 201 and calculate the sagittal height of the lenslet, the RMS radius value of the diffuse plaques generated on the retina at the maximum field of view of its lens-eye system is the value corresponding to the 1.61 sagittal height in Table 5, then compare it with the RMS radius value of the diffuse plaques in Table 8 to calculate the increase rate. It can be seen from Table 9 that when the power of the first lens 201 is increased from 5 μm to 10 μm, the RMS radius value of its diffuse plaques increases by 29.6% to 96.2% compared to the result of constructing the second lens 202 with the 1.61 μm power, therefore, if the size of the diffuse plaques is to be significantly increased, the structural parameters of the second lens 202 need to be redesigned.

TABLE 9

| | | Increase rate of RMS |
|---|---|---|
| Sagittal Height of the | | (Compared with the result of |
| Second Lens 202/μm | RMS/um | 1.61 μm sagittal height) |
| (With the first lens 201 | 20.696 | |
| replacing the second | | |
| lens 202) 1.61 | | |
| 5.00 | 26.823 | 29.6% |
| 6.25 | 29.880 | 44.4% |
| 7.50 | 33.350 | 61.1% |
| 8.75 | 36.847 | 78.0% |
| 10.00 | 40.612 | 96.2% |

In Embodiment 1 and Embodiment 2, the structural design of the second lens 202 was carried out using spherical and parabolic surfaces respectively, in order to compare the diffuse plaques radii of the spherical and parabolic surfaces at the same sagittal height, interpolation calculations were performed on the data in Table 5 of Embodiment 1 to obtain the diffuse plaques radii corresponding to the sagittal height as shown in Table 8, and then a comparison was made with the results in Table 9, the results are shown in Table 10. It can be seen from Table 10 that after using the parabolic surface with the same sagittal height as the spherical surface, the diffuse plaques radius of the lens-eye system is further increased, indicating that the use of an aspherical surface helps to increase the intensity of the diffuse plaques modulation signal.

TABLE 10

| | Sagittal Height | RMS/um | | Increase |
|---|---|---|---|---|
| Serial | of the Second | Embodiment 1/ | Embodiment 2/ | rate of |
| Number | Lens/um | Spherical surface | Parabolic surface | RMS |
| 1 | 5.00 | 25.438 | 26.823 | 5.4% |
| 2 | 6.25 | 28.280 | 29.880 | 5.7% |
| 3 | 7.50 | 31.495 | 33.350 | 5.9% |
| 4 | 8.75 | 34.981 | 36.847 | 5.3% |
| 5 | 10.00 | 38.659 | 40.612 | 5.1% |

It should be noted that the eyeglass lens with the structure of this embodiment, while retaining the traditional peripheral retinal defocus stimulation signal, introduces the diffuse plaques modulation signal. And through the modulation scheme that associates the structural parameters of the lenslet array with the RMS radius value of the diffuse plaques, a connection can be established between the introduced diffuse plaques modulation signal and the shape parameters, thereby precisely setting the diffuse plaques modulation signal in the peripheral retina to achieve the purpose of controlling the development of myopia. Through the alternating distribution of the first lens and the second lens, when the pupil sweeps across the lenslet area, it can cover the modulation area as much as possible, the coexistence of multiple stimulation signals within the sweeping range provides more forms of stimulation mechanisms to inhibit the growth of the eye axis.

The above has provided a detailed introduction to the lenslet eyeglass lens and its design method provided in this application, specific examples have been applied in this text to elaborate on the principles and implementation methods of this application, the description of the above embodiments is only used to help understand the method and its core ideas of this application; meanwhile, for those skilled in the art, based on the ideas of this application, there will be changes in specific implementation methods and application scopes. To sum up, the specification should not be understood as a limitation to the present application.

What is claimed is:

1. A lenslet eyeglass lens, comprising:
a primary lens (10), the primary lens has a modulation zone (100), and the primary lens (10) comprises a first noumenon (101) within the modulation zone (100);
a lenslet (20), the lenslet (20) comprises a first lens (201) and a second lens (202), the first lens (201) is connected to the first noumenon (101) and configured to create defocus when combined with the first noumenon (101), the second lens (202) is also connected to the first noumenon (101) and configured to create a diffuse plaques when combined with the first noumenon (101), and the second lens (202) is connected to the first lens (201) and exposes a part of the first noumenon (101) such that the modulation zone (100) concurrently generates a clear visual signal, a defocus signal, and a diffuse plaques modulation signal.

2. The lenslet eyeglass lens of claim 1, wherein the primary lens (10) has a clear vision zone (200), the primary lens (10) comprises a second noumenon (102) within the clear vision zone (200), the modulation zone (100) surrounds the clear vision zone (200), and the second noumenon (102) is connected to the first noumenon (101), the center of the clear vision zone (200) coincides with the optical center (103) of the primary lens (10), the clear vision zone (200) lies within a region 3 mm to 6 mm away from the optical center (103), and the modulation zone (100) lies within a region 3 mm to 35 mm away from the optical center (103), and wherein
the area of the modulation zone (100) is S₁, and the projected area of the lenslet (20) within the modulation zone (100) along the direction perpendicular to the first noumenon (101) is S₂, satisfying: 0.5≤S₂/S₁≤0.8.

3. The lenslet eyeglass lens of claim 1, wherein the refractive power of the first lens (201) is P₁ D, the refractive power of the second lens (202) is P₂ D, and the refractive power of the first noumenon (101) is P₀ D, satisfying: 2.5≤|P₁-P₀|8.0, and 10≤|P₂-P₀|≤|≤32, and 8≤|P₂-P₁|≤30.

4. The lenslet eyeglass lens of claim 1, wherein the sagittal height of the first lens (201) is H₁ μm, and the sagittal height of the second lens (202) is H₂ μm, satisfying: 2≤H₂/H₁≤20, with 0.5≤H₁≤5, and 1≤H₂≤10.

5. The lenslet eyeglass lens of claim 2, wherein the first noumenon (101) and the second noumenon (102) are integrally molded, the primary lens (10) includes a second optical surface (104) on the eye-facing side and a first optical surface (105) facing away from the second optical surface (104), and wherein the lenslet (20) is located:
on the first optical surface (105), or
on the second optical surface (104), or
between the first optical surface (105) and the second optical surface (104), and
wherein the shape of the first optical surface (105) and second optical surface (104) is selected from at least one of spherical surface, aspherical surface, or freeform curved surface.

6. The lenslet eyeglass lens of claim 1, wherein the shape of the first lens (201) is selected from at least one of spherical surface, aspherical surface, toroidal curved surface, cylindrical surface, or freeform curved surface, and the shape of the second lens (202) is selected from at least one of spherical surface, aspherical surface, toroidal curved surface, cylindrical surface, or freeform curved surface.

7. The lenslet eyeglass lens of claim 1, wherein the diameter of the first lens (201) and the diameter of the second lens (202) are within 0.1-2 mm, the first lens (201) and the second lens (202) are a circular convex lens or a circular concave lens, the sum of the diameter of the first lens (201) and the diameter of the second lens (202) is less than or equal to a pupil diameter.

8. The lenslet eyeglass lens of claim 1, wherein the first lens (201) and the second lens (202) are tangential or contiguous at the edges thereof.

9. The lenslet eyeglass lens of claim 1, wherein the first lens (201) and the second lens (202) are connected alternately in sequence.

10. The lenslet eyeglass lens of claim 1, wherein the diffuse plaques produced by light passing through the second lens (202) on a retina has a first RMS radius value, and the diffuse plaques produced by light passing through the first lens (201) on the retina has a second RMS radius value, with the first RMS radius value being larger than the second RMS radius value.

11. A method for designing a lenslet eyeglass lens, comprising the steps:
providing a primary lens (10), the primary lens (10) has a clear vision zone (200) and a modulation zone (100) surrounding the clear vision zone (200), wherein the primary lens (10) comprises a first noumenon (101) in the modulation zone (100), and grids (300) are arranged in an array in the modulation zone (100) and connected to each other,
providing a first lens (201), the first lens (201) is disposed within the grid (300) and connected to the first noumenon (101), configured to create defocus when combined with the first noumenon (101);
providing a second lens (202), the second lens (202) is disposed within the grids (300) and connected to the first noumenon (101), configured to create a diffuse plaques when combined with the first noumenon (101);
wherein the first lens (201) and the second lens (202) are connected and expose a part of the first noumenon (101), such that the modulation zone (100) concurrently generates a clear visual signal, a defocus signal, and a diffuse plaques modulation signal.

12. The method for designing the lenslet eyeglass lens of claim 11, wherein the grids (300) are shaped as regular polygon, circle, or ellipse.

13. The method for designing the lenslet eyeglass lens of claim 11, wherein the grids (300) are shaped as regular hexagon, and the first lens (201) and the second lens (202) are shaped as inscribed circles within the hexagon.

14. The method for designing the lenslet eyeglass lens of claim 11, wherein the step of providing the primary lens (10) further comprises:
determining a shape parameter of the primary lens (10) based on a prescription and a refractive index of the material of the primary lens and establishing a primary lens model;
the step of providing the first lens (201) further comprises:
determining a shape parameter and a diameter of the first lens (201), positioning the first lens (201) within the modulation zone (100) according to the layout of the grids (300), and forming the first lens (201) on the surface of the primary lens model;
the step of providing the second lens (202) further comprises:
determining a shape parameter and a diameter of the second lens (202), positioning the second lenses (202) within the modulation zone (100) based on the layout of the grids (300), and forming the second lenses (202) on the surface of the primary lens model.

15. The method for designing the lenslet eyeglass lens of claim 14, wherein the step of determining the shape parameter of the second lens (202) further comprises:
conducting an optical simulation on the primary lens model with the first lens (201) and the second lens (202) being formed on the surface thereof, to obtain the size and shape of the diffuse plaques generated by the light passing through a maximum off-axis field of view of the second lens (202) on the retina, thereby determining the RMS radius value of the diffuse plaques;
keeping the diameter of the second lens (202) constant, gradually changing a single-sided mean power or a sagittal height of the second lens (202), and establishing a relationship between the single-sided mean power or the sagittal height and the RMS radius value of the diffuse plaques by regression analysis;
based on the RMS radius value of the diffuse plaques added for a lens wearer, using this relationship to determine the single-sided mean power or the sagittal height of the second lens (202), thereby obtaining the shape parameter of the second lens (202).
